(19) United States
(12) Patent Application Publication
(10) Pub. No.: US 2005/0048826 A1
(43) Pub. Date: Mar. 3, 2005

(54) Socket connector with anti-distortion functions

(76) Inventors: A-Lu Chen, Tu-Chen (TW); Hsiu-Yuan Hsu, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/934,849

(22) Filed: Sep. 3, 2004

(30) Foreign Application Priority Data
Sep. 3, 2003 (TW) 92124288

(51) Int. Cl. H01R 11/22

(52) U.S. Cl. 439/268

(57) ABSTRACT

A socket connector (1) includes a base (10), a movable plate (20) movably mounting on the base (10), a cover (30) mounting on the movable plate, a number of springs (40), a pair of auxiliary members (50), a pair of actuators (60) actuating the movable plate moving in horizontal directions and a pair of auxiliary plates (80, 82). The base defines a number of second receiving holes (101) and is formed with a placing portion (103). The movable plate mounts on the base and is movable relative to the base from a rest position and an operating position. The movable plate has an engaging hole (206). The actuator engages with the placing portion of the base and the engaging hole of movable plate, and actuates the movable plate moving between the rest position and the operating position. The cover mounts above the movable plate. The first auxiliary plate (80) mounts with the base. The second auxiliary plate (82) mounts above the cover. The springs interconnect the auxiliary plates.

### BACKGROUND OF THE INVENTION

1. Field of the Invention

The present invention relates to an electrically socket connector, especially to an electrically socket connector with anti-distortion functions used for testing Integrated Circuit chip (hereinafter simple for IC chip).

2. Description of Related Art

A socket connector is widely used for IC chip test. A conventional socket connector comprises a base, a movable plate mounting on the base and a plurality of actuators for actuating the movable plate moving relatively to the base. The movable plate is movable between a rest position and an operating position. Such socket connectors are disclosed in U.S. Pat. No. 5,186,642 and No. 5,690,281.

Referring to FIG. 3, a conventional socket connector 9 used for IC chip tests comprises a squared flat base 90, a movable plate 91 mounting on the base 90 and movable relative to the base 90, a cover 92, a plurality of springs 96, an auxiliary member 93 and a pair of actuators 95.

The movable plate 91 is a squared plan plate with a squared central portion cut away. The movable plate 91 comprises a plurality of first receiving holes 911 arranged in lines around the squared central portion for receiving pins of the IC chip therein. A pair of guiding portions 914 is formed at corner portions of a rear side edge of the movable plate 91. Each guiding portion 914 defines a first engaging hole 916.

The base 90 is a flat and plan plate, and defines a squared cutout at a central portion corresponding to the squared central portion of the movable plate 91. A plurality of second receiving holes 901 is defined through the base 90 corresponding to the first receiving holes 911. A pair of placing portions 903 is formed at opposite lateral side edges adjacent to the front side edge. Four third receiving holes 9012 are defined at corner portions of the base 90.

The cover 92 is a frame and defines an opening 921 at the central portion thereof, thus the first receiving holes 911 of the movable plate 91 are upwardly exposed. A plurality of forth receiving holes (not shown) is defined on a lower surface of corner portions of the cover 92 corresponding to the third receiving holes 9012. A pair of positioning holes 924 is defines at each lateral side of the cover 92.

In assembly, the movable plate 91 are mounted on the base 90, the first receiving holes 901 respectively correspond to the second receiving holes 911. The auxiliary member 93 fixes with the cover 92 through fastening with the positioning holes 924. The actuators 95 respectively assemble with the corresponding auxiliary member 93 and engage with the first engaging hole 916 of the movable plate 91 and the placing portion 903 of the base 90. Four springs 96 are received in the third receiving holes 9012 and the forth receiving holes. In operation, an external force is exerted on the cover 92 and the cover 92 is pressed downwardly thereby the movable plate 91 being actuated from the rest position to the operating position. Because of reserve forces of the springs 96 exerted on corner portions of the cover 92, the cover 92 is easily distorted. However, a distortion of the cover 92 may lead unreliable contacts of the IC chip and the movable plate 91.

Hence, an improved socket connector is required to overcome the disadvantages of the prior art.

### BRIEF SUMMARY OF THE INVENTION

An object of the present invention is to provide a new socket connector capable of avoiding distortions of the cover.

A socket connector with anti-distortion function comprises a pair of auxiliary plate, a base, a movable plate, a cover and an actuator. The base defines a plurality of second receiving holes and is formed with a placing portion. The movable plate is mounted on the base and is movable relative to the base between a rest position and an operating position. The movable plate has an engaging portion formed at a backside edge. The actuator engages with the placing portion of the base and the engaging portion of the movable plate. The actuator actuates the movable plate moving between the rest position and the operating position. The cover is mounted above the movable plate. A first auxiliary plate mounts with the base. A second auxiliary plate mounts above the cover. A plurality of springs interconnects the auxiliary plates and provides the second auxiliary plate restoring force.

While an external force exerts on the second auxiliary plate, the springs distort between the first auxiliary plate and the second auxiliary plate. There's not any reverse force from the springs exerting on the cover, thus, the cover may avoid a distortion.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is an exploded perspective view in according to the present invention;

FIG. 2 is an assembled view of FIG. 1; and

FIG. 3 is an exploded perspective view of a conventional socket connector.

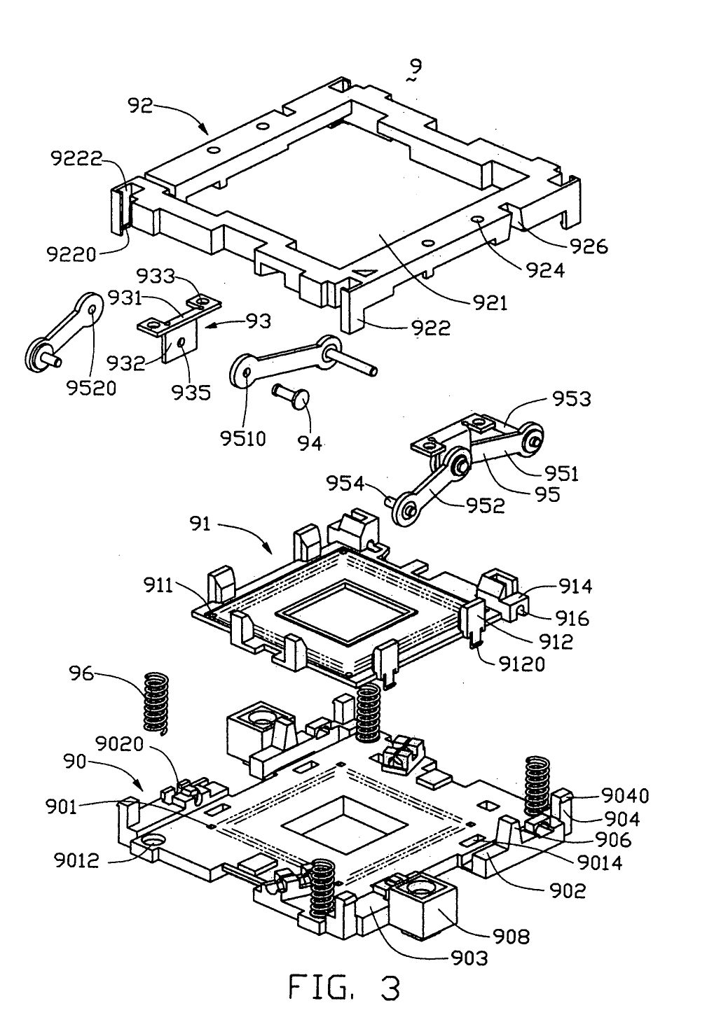

### DETAILED DESCRIPTION OF THE PREFERRED EMBODIMENTS

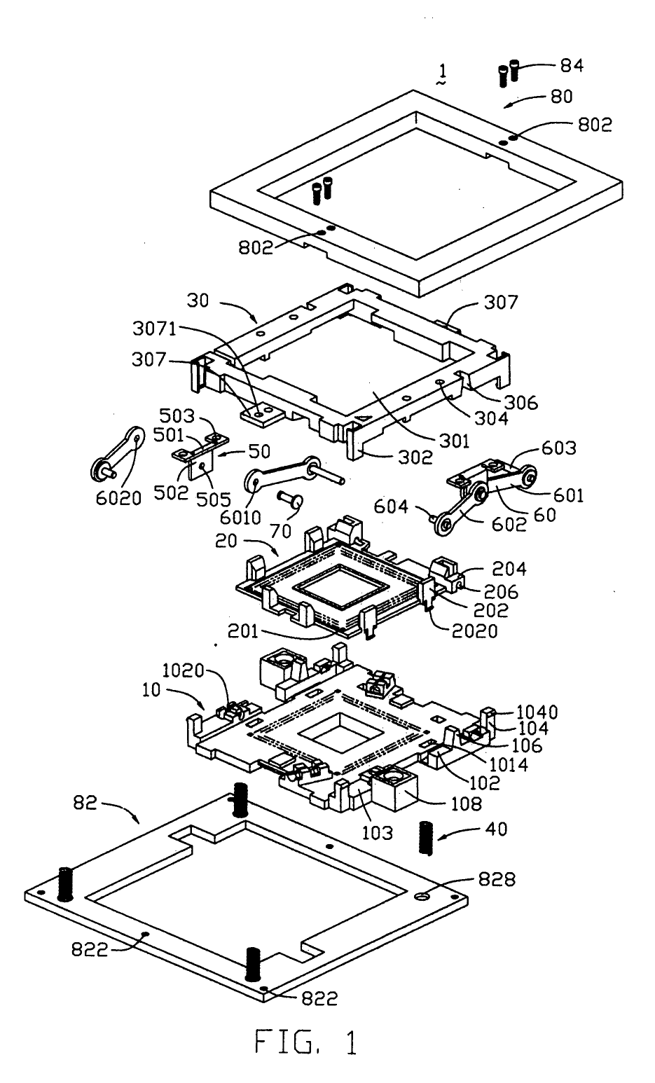

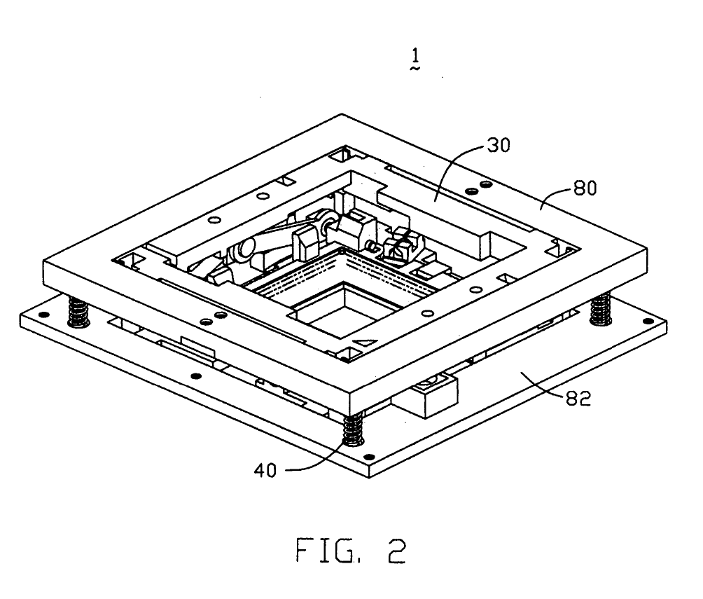

Referring to FIGS. 1 and 2, a socket connector 1 in accordance with the present invention used for interconnecting an IC chip (not shown) and a PCB (not shown) to test the IC chip, comprises a base 10, a movable plate 20 mounting on the base 10 and movably relative to the base 10, a cover 30 mounting on the movable plate 20, a plurality of springs 40, a pair of auxiliary members 50, a pair of actuators 60 actuating the movable plate 20 moving in horizontal directions and a pair of auxiliary plates 80, 82.

The movable plate 20 is a squared plan plate with a squared central portion cut away. The movable plate 20 comprises a plurality of first receiving holes 201 arranged in lines around the squared central portion for receiving pins of the IC chip therein. A pair of guiding portions 204 is formed at corner portions of a rear side edge of the movable plate 20. Each guiding portion 204 defines a first engaging hole 206. A plurality of locking portions 202 is formed at opposite lateral side edges of the movable plate 20. A tab 2020 laterally extends from a lower end of one locking portion 202.

The base 10 has a flat and lengthwise configuration, and defines a squared cutout at a central portion corresponding to the squared central portion of the movable plate 20. A plurality of second receiving holes 101 is defined through on the base 10 corresponding to the first receiving holes 101. A pair of placing portions 103 is formed at opposite lateral side edges adjacent to the front side edge. Each placing portion 103 defines a first engaging trough 1020. A pair of lengthwise slits 1014 is symmetrically defined on the base 10 adjacent to each lateral side edge and parallel with the lateral side edge. A pair of positioning portions 102 is respectively formed at lateral side edge and adjacent to the rear side edge. A projection 106 upwardly projects from each positioning portion 102. Four clasping portions 104 respectively and upwardly projecting from corner portions of the positioning portions 102 and the placing portions 103. Each clasping portion 104 forms a clasping end 1040 at a free end thereof.

The cover 30 substantially is a frame. The cover 30 defines an opening 301 at the central portion thereof, thus the movable plate 20 are upwardly exposed. A pair of first positioning holes 304 is defines at each lateral side of the cover 30. A pair of recesses 306 is defined at lateral side of the cover 30 corresponding to the projections 106 of the base 10. The cover 30 also comprises a plurality of second engaging troughs 302 defining at corner portions corresponding to the clasping portions 104 formed on the base 10. A pair of engaging tabs 307 respectively and horizontally extends from a front side edge and a rear side edge of the cover 30 in opposite directions. The engaging tabs 307 each defines a pair of second engaging holes 3071 therethrough.

The auxiliary member 50 comprises a horizontal portion 501 and a vertical portion 502 extending downwardly from the horizontal portion 501. The horizontal portion 501 defines a pair of second positioning holes 503 corresponding to the first positioning holes 304. The vertical portion 502 defines a positioning hollow 505 thererthrough. The actuators 60 engage with the auxiliary members 50. The actuator 60 includes a first operating arm 601 and a second operating arm 602. The first operating arm 601 defines a first operating hollow 6010. The second operating arm 602 defines a second operating hollow 6020. A first bolt 70 bolts through the first operating hollow 6010, the second operating hollow 6020 and the positioning hollow 505 thereby securing the actuator 60 with the auxiliary member 50 and ensuring pivotal movements of the actuator 60. The first operating arm 601 has a first pole 603 laterally extending from a free end in a same direction as the horizontal portion 501 extends. The second operating arm 602 has a second pole 604 extending from a free end in a same direction as the first pole 603 extends.

The auxiliary plates comprise a first auxiliary plate 82 and a second auxiliary plate 80. The auxiliary plates substantially are squared frames. The first auxiliary plate 82 comprises a plurality of third positioning holes 822 defined through at corner portions and middle portions of opposite side thereof. Four third receiving holes 828 are defined at corner portions of the first auxiliary plate to receive the springs 40. The second auxiliary plate 80 comprises a plurality of third engaging holes 802 corresponding to the second engaging holes 3071 defined on the engaging tabs 307. Four forth receiving holes (not shown) is defined at lower surface of the second auxiliary plate 80.

In assembly, the first auxiliary plate 82 is fixed by bolting the third positioning holes 822 with the PCB. The base 10 mounts on the PCB and engages with the first auxiliary plate 82. The movable plate 20 mounts on the base 10 and the locking portions 202 of the movable plate 20 insert through the slits 1014 and lock with the PCB. As the slits 1014 are wider than the locking portion 202 in longitudinal direction, the slits 1014 are able to guide longitudinal movements of the movable plate 20. The actuators 60 respectively engage with the auxiliary members 50. The first bolt 70 bolts through the first operating hollow 6010 of the first operating arm 601, the second operating hollow 6020 of the second operating arm 602 and the positioning hollow 505 of the auxiliary member 501 thereby securing the actuator 60 with the auxiliary member 50 and ensuring pivotal movements of the actuator 60. The first poles 603 of the first operating arms 601 engage with the operating arms 601 engage with the first engaging hole 206 of the movable plate 20, and the second poles 604 engage with the first engaging trough 1020. The auxiliary members 50 secure with the cover 30 by bolting the first positioning holes 304 and the second positioning holes 503. The clasping portions 104 engage with the second engaging trough 302. The projections 106 engage with the recesses 306. The second auxiliary plate 80 mounts on the cover 30. Second bolts 84 insert into the third engaging holes 802 and the second engaging holes 3071 thereby fixing the second auxiliary plate 80 with the cover 30. The third receiving holes 828 receive the springs 40, and the forth receiving holes of the second auxiliary plate 80 receive the free ends of the springs 40.

In normal, the movable plate 20 is at the rest position. In operation, an external force is exerted on the second auxiliary plate 80 or the cover 30. The second auxiliary plate 80 or the cover 30 is pressed down which causes pivotal movements of the first operating arm 601 and the second operating arm 602 in opposite direction. Because the second operating arms 602 engage with base 10 which is fixed with the PCB, in the pivotal movements, the free ends of the first operating arms 601 move away and take the movable plate 20 to the operating position. When the external force removes, the cover 30 is raised as a reserve operating force of the spring 40, and the first operating arm 601 and the second operating arm 602 move toward each other, thus the movable plate 20 is taken to the rest position.

It will be understood that the invention may be embodied in other specific forms without departing from the spirit or central characteristics thereof. The present examples and embodiments, therefore, are to be considered in all respects as illustrative and not restrictive, and the invention is not be limited to the details given herein.

1. A socket connector comprising:
a base defining a plurality of second receiving holes and formed with a placing portion;
a movable plate mounted on the base, having an engaging portion and being movable relative to the base from a rest position and an operating position;
an actuator engaging with the placing portion of the base and the engaging portion of movable plate, and actuating the movable plate moving between the rest position and the operating position;
a cover mounting above the movable plate;
a first auxiliary plate mounting with the base, a second auxiliary plate mounting with the cover; and
a plurality of springs between the auxiliary plates.

2. The socket connector as claimed in claim 1, wherein the auxiliary members are secured with the cover by bolting.

3. The socket connector as claimed in claim 1, wherein the cover is secured with the second auxiliary plate by bolting.

4. The socket connector as claimed in claim 1, wherein the movable plate defines a plurality of receiving holes for pins of an Interacted Circuit chip receiving therein.

5. The socket connector as claimed in claim 1, wherein the movable plate forms a plurality of locking portions, the base defines a plurality of slits corresponding to the locking portions, and the locking portions respectively engage with the corresponding slits.

6. A socket connector comprising:
a base;
a plate mounted on the base and being moveable relative to the base along a front-to-back direction;
an actuator performing a movement along both the front-to-back direction and a vertical direction perpendicular to said front-to-back direction;
a cover located above the plate and vertically moveably engaged with the base;
said actuator respectively engaged with the base, the plate and the cover to transform a vertical movement of the cover relative to the base to a horizontal movement of the plate relative to the base;
a first auxiliary plate eagageably located below the base, a second auxiliary plate engageably located above the cover; and
a plurality of springs between the auxiliary plates.
